(19) United States
(12) Patent Application Publication
(10) Pub. No.: US 2025/0047435 A1
(43) Pub. Date: Feb. 6, 2025

(54) CONFLICT AVOIDANCE FOR REFERENCE SIGNAL

(71) Applicant: Nokia Technologies Oy, Espoo (FI)

(72) Inventors: Nuno Manuel KIILERICH PRATAS, Aalborg (DK); Oana-Elena BARBU, Aalborg (DK); Benny VEJLGAARD, Aalborg (DK); Johannes HARREBEK, Aalborg (DK); Jan Torst HVIID, Aalborg (DK); Prajwal KESHAVAMURTHY, Munich (DE)

(21) Appl. No.: 18/715,389

(22) PCT Filed: Dec. 15, 2021
(86) PCT No.: PCT/EP2021/085969

§ 371 Date: May 31, 2024

(51) Int. Cl. H04L 5/00; G01S 13/76; H04W 72/40

(52) U.S. Cl. CPC H04L 5/0048; G01S 13/765; H04W 72/40

(57) ABSTRACT

Disclosed is a method comprising receiving, by a first terminal device, from a second terminal device, a first message indicating a first set of resource configurations for transmission of a reference signal to the second terminal device: transmitting, by the first terminal device, a second message indicating a second set of resource configurations for the transmission of the reference signal to the second terminal device, wherein the second set of resource configurations are generated based at least partly on the first set of resource configurations; receiving, by the first terminal device, from the second terminal device, a third message indicating a resource configuration to be used for the transmission of the reference signal to the second terminal device; and transmitting, by the first terminal device, to the second terminal device, the reference signal based at least partly on the resource configuration indicated in the third message.

### FIELD

The following exemplary embodiments relate to wireless communication and to positioning.

### BACKGROUND

Positioning technologies may be used to estimate a physical location of a device. There is a challenge in how to address conflicting resource configurations for positioning reference signals.

### SUMMARY

The scope of protection sought for various exemplary embodiments is set out by the claims. The exemplary embodiments and features, if any, described in this specification that do not fall under the scope of the claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: receive, from a terminal device, a first message indicating a first set of resource configurations for transmission of a reference signal to the terminal device; transmit a second message indicating a second set of resource configurations for the transmission of the reference signal to the terminal device, wherein the second set of resource configurations are generated based at least partly on the first set of resource configurations; receive, from the terminal device, a third message indicating a resource configuration to be used for the transmission of the reference signal to the terminal device; and transmit, to the terminal device, the reference signal based at least partly on the resource configuration indicated in the third message.

According to another aspect, there is provided an apparatus comprising means for: receiving, from a terminal device, a first message indicating a first set of resource configurations for transmission of a reference signal to the terminal device; transmitting a second message indicating a second set of resource configurations for the transmission of the reference signal to the terminal device, wherein the second set of resource configurations are generated based at least partly on the first set of resource configurations; receiving, from the terminal device, a third message indicating a resource configuration to be used for the transmission of the reference signal to the terminal device; and transmitting, to the terminal device, the reference signal based at least partly on the resource configuration indicated in the third message.

According to another aspect, there is provided a method comprising: receiving, by a first terminal device, from a second terminal device, a first message indicating a first set of resource configurations for transmission of a reference signal to the second terminal device; transmitting, by the first terminal device, a second message indicating a second set of resource configurations for the transmission of the reference signal to the second terminal device, wherein the second set of resource configurations are generated based at least partly on the first set of resource configurations; receiving, by the first terminal device, from the second terminal device, a third message indicating a resource configuration to be used for the transmission of the reference signal to the second terminal device; and transmitting, by the first terminal device, to the second terminal device, the reference signal based at least partly on the resource configuration indicated in the third message.

According to another aspect, there is provided a computer program product comprising program instructions which, when run on a computing apparatus, cause the computing apparatus to perform at least the following: receiving, from a terminal device, a first message indicating a first set of resource configurations for transmission of a reference signal to the terminal device; transmitting a second message indicating a second set of resource configurations for the transmission of the reference signal to the terminal device, wherein the second set of resource configurations are generated based at least partly on the first set of resource configurations; receiving, from the terminal device, a third message indicating a resource configuration to be used for the transmission of the reference signal to the terminal device; and transmitting, to the terminal device, the reference signal based at least partly on the resource configuration indicated in the third message.

According to another aspect, there is provided a computer program comprising instructions for causing an apparatus to perform at least the following: receiving, from a terminal device, a first message indicating a first set of resource configurations for transmission of a reference signal to the terminal device; transmitting a second message indicating a second set of resource configurations for the transmission of the reference signal to the terminal device, wherein the second set of resource configurations are generated based at least partly on the first set of resource configurations; receiving, from the terminal device, a third message indicating a resource configuration to be used for the transmission of the reference signal to the terminal device; and transmitting, to the terminal device, the reference signal based at least partly on the resource configuration indicated in the third message.

According to another aspect, there is provided a computer readable medium comprising program instructions for causing an apparatus to perform at least the following: receiving, from a terminal device, a first message indicating a first set of resource configurations for transmission of a reference signal to the terminal device; transmitting a second message indicating a second set of resource configurations for the transmission of the reference signal to the terminal device, wherein the second set of resource configurations are generated based at least partly on the first set of resource configurations; receiving, from the terminal device, a third message indicating a resource configuration to be used for the transmission of the reference signal to the terminal device; and transmitting, to the terminal device, the reference signal based at least partly on the resource configuration indicated in the third message.

According to another aspect, there is provided a non-transitory computer readable medium comprising program instructions for causing an apparatus to perform at least the following: receiving, from a terminal device, a first message indicating a first set of resource configurations for transmission of a reference signal to the terminal device; transmitting a second message indicating a second set of resource configurations for the transmission of the reference signal to the terminal device, wherein the second set of resource configurations are generated based at least partly on the first set of resource configurations; receiving, from the terminal device, a third message indicating a resource configuration to be used for the transmission of the reference signal to the terminal device; and transmitting, to the terminal device, the reference signal based at least partly on the resource configuration indicated in the third message.

According to another aspect, there is provided an apparatus comprising at least one processor, and at least one memory including computer program code, wherein the at least one memory and the computer program code are configured, with the at least one processor, to cause the apparatus to: transmit a first message indicating a first set of resource configurations for transmission of a reference signal; receive, from one or more terminal devices, one or more second messages indicating a second set of resource configurations for the transmission of the reference signal from the one or more terminal devices; determine, based at least partly on the second set of resource configurations, at least one resource configuration to be used for the transmission of the reference signal for at least one terminal device of the one or more terminal devices; transmit a third message indicating the at least one resource configuration for the at least one terminal device; and receive, from the at least one terminal device, the reference signal based at least partly on the at least one resource configuration indicated in the third message.

According to another aspect, there is provided an apparatus comprising means for: transmitting a first message indicating a first set of resource configurations for transmission of a reference signal; receiving, from one or more terminal devices, one or more second messages indicating a second set of resource configurations for the transmission of the reference signal from the one or more terminal devices; determining, based at least partly on the second set of resource configurations, at least one resource configuration to be used for the transmission of the reference signal for at least one terminal device of the one or more terminal devices; transmitting a third message indicating the at least one resource configuration for the at least one terminal device; and receiving, from the at least one terminal device, the reference signal based at least partly on the at least one resource configuration indicated in the third message.

According to another aspect, there is provided a method comprising: transmitting, by a second terminal device, a first message indicating a first set of resource configurations for transmission of a reference signal; receiving, by the second terminal device, from one or more first terminal devices, one or more second messages indicating a second set of resource configurations for the transmission of the reference signal from the one or more first terminal devices; determining, by the second terminal device, based at least partly on the second set of resource configurations, at least one resource configuration to be used for the transmission of the reference signal for at least one terminal device of the one or more first terminal devices; transmitting, by the second terminal device, a third message indicating the at least one resource configuration for the at least one terminal device; and receiving, by the second terminal device, from the at least one terminal device, the reference signal based at least partly on the at least one resource configuration indicated in the third message.

According to another aspect, there is provided a computer program comprising instructions for causing an apparatus to perform at least the following: transmitting a first message indicating a first set of resource configurations for transmission of a reference signal; receiving, from one or more terminal devices, one or more second messages indicating a second set of resource configurations for the transmission of the reference signal from the one or more terminal devices; determining, based at least partly on the second set of resource configurations, at least one resource configuration to be used for the transmission of the reference signal for at least one terminal device of the one or more terminal devices; transmitting a third message indicating the at least one resource configuration for the at least one terminal device; and receiving, from the at least one terminal device, the reference signal based at least partly on the at least one resource configuration indicated in the third message.

According to another aspect, there is provided a computer program product comprising program instructions which, when run on a computing apparatus, cause the computing apparatus to perform at least the following: transmitting a first message indicating a first set of resource configurations for transmission of a reference signal; receiving, from one or more terminal devices, one or more second messages indicating a second set of resource configurations for the transmission of the reference signal from the one or more terminal devices; determining, based at least partly on the second set of resource configurations, at least one resource configuration to be used for the transmission of the reference signal for at least one terminal device of the one or more terminal devices; transmitting a third message indicating the at least one resource configuration for the at least one terminal device; and receiving, from the at least one terminal device, the reference signal based at least partly on the at least one resource configuration indicated in the third message.

According to another aspect, there is provided a computer readable medium comprising program instructions for causing an apparatus to perform at least the following: transmitting a first message indicating a first set of resource configurations for transmission of a reference signal; receiving, from one or more terminal devices, one or more second messages indicating a second set of resource configurations for the transmission of the reference signal from the one or more terminal devices; determining, based at least partly on the second set of resource configurations, at least one resource configuration to be used for the transmission of the reference signal for at least one terminal device of the one or more terminal devices; transmitting a third message indicating the at least one resource configuration for the at least one terminal device; and receiving, from the at least one terminal device, the reference signal based at least partly on the at least one resource configuration indicated in the third message.

According to another aspect, there is provided a non-transitory computer readable medium comprising program instructions for causing an apparatus to perform at least the following: transmitting a first message indicating a first set of resource configurations for transmission of a reference signal; receiving, from one or more terminal devices, one or more second messages indicating a second set of resource configurations for the transmission of the reference signal from the one or more terminal devices; determining, based at least partly on the second set of resource configurations, at least one resource configuration to be used for the transmission of the reference signal for at least one terminal device of the one or more terminal devices; transmitting a third message indicating the at least one resource configuration for the at least one terminal device; and receiving, from the at least one terminal device, the reference signal based at least partly on the at least one resource configuration indicated in the third message.

According to another aspect, there is provided a system comprising at least a first terminal device and a second terminal device. The first terminal device is configured to: receive, from the second terminal device, a first message indicating a first set of resource configurations for transmission of a reference signal to the second terminal device; transmit a second message indicating a second set of resource configurations for the transmission of the reference signal to the second terminal device, wherein the second set of resource configurations are generated based at least partly on the first set of resource configurations; receive, from the second terminal device, a third message indicating a resource configuration to be used for the transmission of the reference signal to the second terminal device; and transmit, to the second terminal device, the reference signal based at least partly on the resource configuration indicated in the third message. The second terminal device is configured to: transmit the first message indicating the first set of resource configurations for the transmission of the reference signal to the second terminal device; receive, from the first terminal device, the second message indicating the second set of resource configurations for the transmission of the reference signal to the second terminal device; determine, based at least partly on the second set of resource configurations, the resource configuration to be used for the transmission of the reference signal to the second terminal device; transmit the third message indicating the resource configuration to be used for the transmission of the reference signal to the second terminal device; and receive, from the first terminal device, the reference signal based at least partly on the resource configuration indicated in the third message.

According to another aspect, there is provided a system comprising at least a first terminal device and a second terminal device. The first terminal device comprises means for: receiving, from the second terminal device, a first message indicating a first set of resource configurations for transmission of a reference signal to the second terminal device; transmitting a second message indicating a second set of resource configurations for the transmission of the reference signal to the second terminal device, wherein the second set of resource configurations are generated based at least partly on the first set of resource configurations; receiving, from the second terminal device, a third message indicating a resource configuration to be used for the transmission of the reference signal to the second terminal device; and transmitting, to the second terminal device, the reference signal based at least partly on the resource configuration indicated in the third message. The second terminal device comprises means for: transmitting the first message indicating the first set of resource configurations for the transmission of the reference signal to the second terminal device; receiving, from the first terminal device, the second message indicating the second set of resource configurations for the transmission of the reference signal to the second terminal device; determining, based at least partly on the second set of resource configurations, the resource configuration to be used for the transmission of the reference signal to the second terminal device; transmitting the third message indicating the resource configuration to be used for the transmission of the reference signal to the second terminal device; and receiving, from the first terminal device, the reference signal based at least partly on the resource configuration indicated in the third message.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates sidelink positioning scenarios;

FIGS. 3a and 3b illustrate new radio sidelink modes;

FIG. 4 illustrates resource coordination between terminal devices;

FIG. 5 illustrates an example of a sidelink positioning reference signal conflict scenario;

FIG. 6 illustrates a signaling diagram according to an exemplary embodiment;

FIGS. 7-9 illustrate flow charts according to some exemplary embodiments;

FIG. 10 illustrates an apparatus according to an exemplary embodiment.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A), new radio (NR, 5G), or beyond 5G, without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

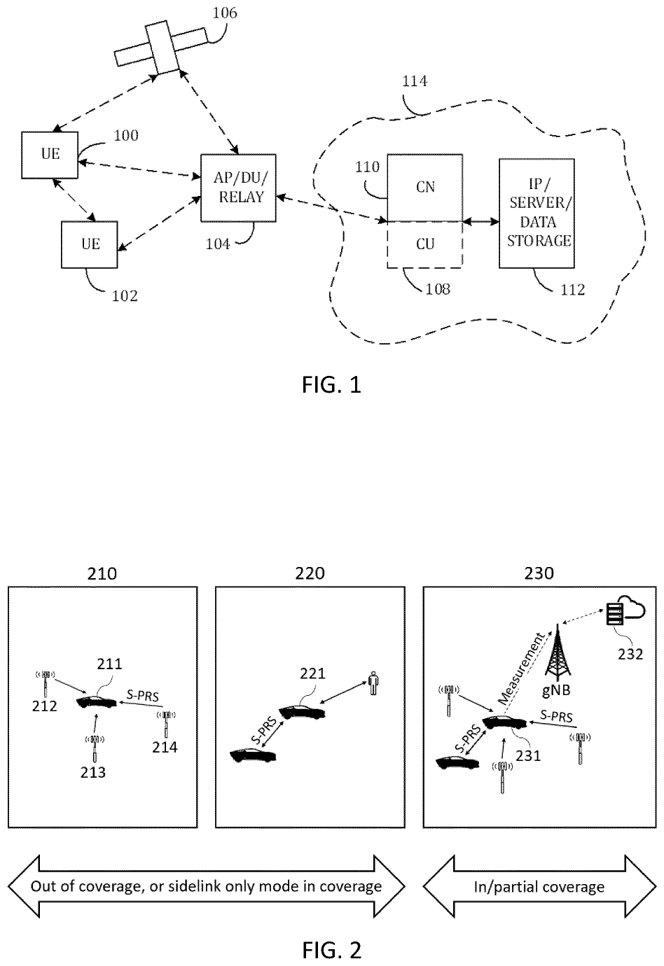

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g) NodeB) 104 providing the cell. The physical link from a user device to a (e/g) NodeB may be called uplink or reverse link and the physical link from the (e/g) NodeB to the user device may be called downlink or forward link. It should be appreciated that (e/g) NodeBs or their functionalities may be implemented by using any node, host, server or access point etc. entity suitable for such a usage.

A communication system may comprise more than one (e/g) NodeB, in which case the (e/g) NodeBs may also be configured to communicate with one another over links, wired or wireless, designed for the purpose. These links may be used for signaling purposes. The (e/g) NodeB may be a computing device configured to control the radio resources of communication system it is coupled to. The (e/g) NodeB may also be referred to as a base station, an access point or any other type of interfacing device including a relay station capable of operating in a wireless environment. The (e/g) NodeB may include or be coupled to transceivers. From the transceivers of the (e/g) NodeB, a connection may be provided to an antenna unit that establishes bi-directional radio links to user devices. The antenna unit may comprise a plurality of antennas or antenna elements. The (e/g) NodeB may further be connected to core network 110 (CN or next generation core NGC). Depending on the system, the counterpart on the CN side may be a serving gateway (S-GW, routing and forwarding user data packets), packet data network gateway (P-GW) for providing connectivity of user devices (UEs) to external packet data networks, mobility management entity (MME), access and mobility management function (AMF), or location management function (LMF), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s), and/or between the IAB node and other IAB nodes (multi-hop scenario).

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may also comprise other apparatuses, such as physical layer relay nodes or other network elements, etc. At least one of the (e/g) NodeBs or may be a Home (e/g) nodeB.

Furthermore, the (e/g) nodeB or base station may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g) nodeB or base station. The DU may be defined as a logical node hosting radio link control (RLC), medium access control (MAC) and/or physical (PHY) layers of the (e/g) nodeB or base station. The operation of the DU may be at least partly controlled by the CU. The CU may comprise a control plane (CU-CP), which may be defined as a logical node hosting the RRC and the control plane part of the PDCP protocol of the CU for the (e/g) nodeB or base station. The CU may further comprise a user plane (CU-UP), which may be defined as a logical node hosting the user plane part of the PDCP protocol and the SDAP protocol of the CU for the (e/g) nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. In multilayer networks, one access node may provide one kind of a cell or cells, and thus a plurality of (e/g) NodeBs may be needed to provide such a network structure.

For fulfilling the need for improving the deployment and performance of communication systems, the concept of “plug-and-play” (e/g) NodeBs may be introduced. A network which may be able to use “plug-and-play” (e/g) NodeBs, may include, in addition to Home (e/g) NodeBs (H (e/g) nodeBs), a home node B gateway, or HNB-GW (not shown in FIG. 1). A HNB Gateway (HNB-GW), which may be installed within an operator's network, may aggregate traffic from a large number of HNBs back to a core network.

Positioning techniques may be used to estimate a physical location of a UE. For example, the following positioning techniques are specified for NR Rel-16: downlink time difference of arrival (DL-TDoA), uplink time difference of arrival (UL-TDoA), downlink angle of departure (DL-AoD), uplink angle of arrival (UL-AoA), and multi-cell round trip time (multi-RTT). Both RAT-dependent as well as RAT-independent NR positioning techniques may be used. RAT is an abbreviation for radio access technology.

NR Rel-16 introduced UE-based positioning for DL techniques (e.g., DL-TDoA), which means that the UE makes both the positioning measurements and the location estimate locally. In the UE-based mode, the location of the gNB(s) may be sent to the UE for use in the location estimation process.

The positioning reference signal (PRS) and/or sounding reference signal (SRS) may be used as reference signals for estimating the location of the UE. PRS is a reference signal for positioning in the downlink (DL). SRS is a reference signal that may be used for positioning in the uplink (UL). It should be noted that SRS may also be used for other purposes than positioning. In an NR system, there may be two types of SRS and those SRS may be separately configured to a UE from a gNB. One is SRS for MIMO introduced in NR Rel-15 and another one is SRS for positioning purpose, which has been introduced in NR Rel-16, where SRS for MIMO can also be used for positioning.

For NR Rel-17, there is a target to specify methods, measurements, signaling, and procedures for improving the positioning accuracy of the NR Rel-16 positioning techniques by mitigating UE Rx/Tx and/or gNB Rx/Tx timing delays, including DL-based, UL-based, and DL+UL-based positioning techniques, as well as UE-based and UE-assisted positioning solutions.

For NR Rel-17, there is also a target to specify the procedure, measurements, reporting, and signaling for improving the accuracy of UL-AoA for network-based positioning solutions, as well as DL-AoD for UE-based and network-based (including UE-assisted) positioning solutions.

For NR Rel-17, there is also a target to specify methods, measurements, signaling and procedures to support positioning for UEs in RRC_INACTIVE state, for UE-based and UE-assisted positioning solutions, including DL NR positioning techniques and RAT-independent positioning techniques. This may involve support of UE positioning measurements for UEs in RRC_INACTIVE state, and reporting of positioning measurement or location estimate performed in RRC_INACTIVE when the UE is in RRC_INACTIVE state.

For NR Rel-17, there is also a target to define extensions of signaling, protocol and procedure for NR positioning enhancement.

In NR Rel-18, there is a target to provide expanded and improved positioning with the following example areas: sidelink positioning/ranging, improved accuracy, integrity and power efficiency, as well as reduced capability (RedCap) positioning. The following are identified in terms of requirements: ranging, low-power positioning, accuracy enhancements (e.g., down to centimeter-level), RAT-dependent positioning integrity, and latency reduction.

For ranging, the most identified technique is sidelink-based.

Low-power positioning is targeted for example at RedCap devices, but may also be applicable to other devices. Support for positioning in RRC_IDLE mode may be the most identified technique here.

The main techniques proposed for accuracy enhancement in general (apart from sidelink assistance) are terrestrial carrier-phase positioning, PRS/SRS bandwidth aggregation, and the use of wide bandwidths for example at 60 GHz (which also implies the ability to transmit PRS in unlicensed spectrum, which may be relevant for sidelink positioning).

The proposed objectives are to provide sidelink-based and sidelink-assisted positioning, low-power positioning (including for RedCap devices, including positioning in RRC_IDLE as well as RRC_INACTIVE state), enhanced accuracy (carrier-phase positioning and PRS/SRS bandwidth aggregation), PRS transmission in unlicensed spectrum (including 60 GHz), and mobile termination (MT) triggered small data transmission (SDT) (at least for network-initiated positioning use case).

FIG. 2 illustrates sidelink positioning scenarios. Sidelink positioning may support at least the following use cases: sidelink absolute 210, sidelink relative 220, and sidelink assisted 230.

In sidelink absolute 210, the position of a target UE 211 (e.g., a vehicle) is based on the anchor devices 212, 213, 214 (known location) such as road-side units (RSU), wherein their absolute location (longitude and latitude) is known.

In sidelink relative 220, the distance and angle are calculated by the target UE 221 via the exchange of sidelink positioning reference signals (S-PRS), and the relative location is known.

In sidelink assisted 230, the position of a target UE 231 is calculated by a location server (LCS) 232, and the absolute location (longitude and latitude) is known.

In NR Rel-16 and beyond, NR sidelink (SL) enables a UE to communicate directly with other nearby UE(s) via sidelink communication. Two resource allocation modes have been specified, and an SL transmitter (Tx) UE may be configured with one of them to perform its sidelink transmission(s). These modes are denoted as NR SL mode 1 and NR SL mode 2. In NR SL mode 1, a sidelink transmission resource is assigned by the network to the SL Tx UE, whereas an SL Tx UE in NR SL mode 2 autonomously selects its SL transmission resources.

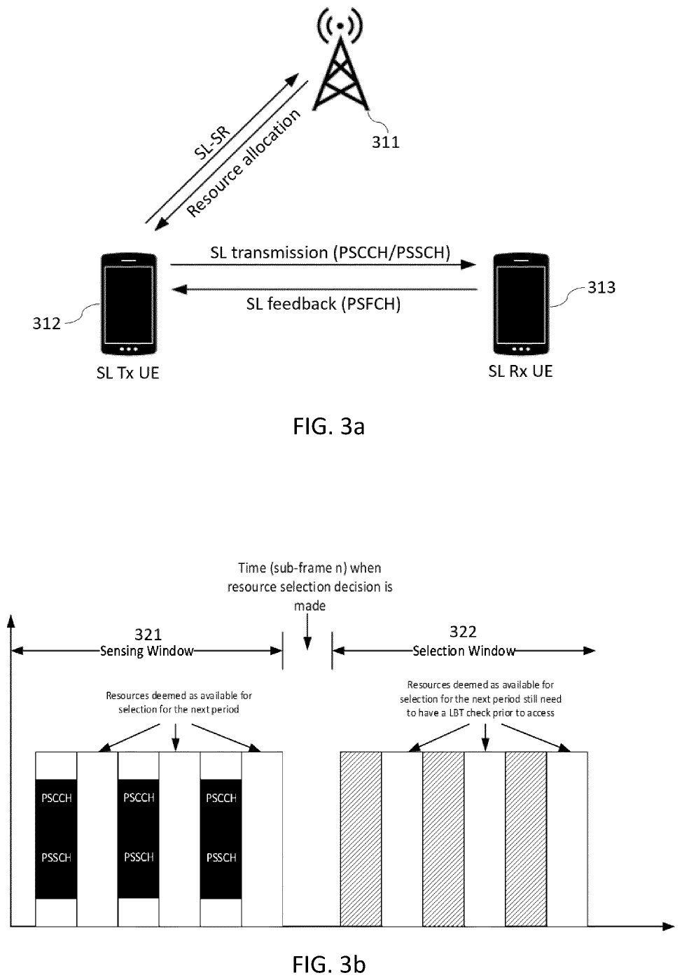

FIG. 3a illustrates NR SL mode 1. In NR SL mode 1, where the gNB 311 is responsible for the SL resource allocation for the SL UEs 312, 313, the configuration and operation is similar to the one over the Uu interface. Referring to FIG. 3a, an SL Tx UE 312 transmits a sidelink scheduling request (SL-SR) to the gNB 312. The gNB 311 indicates an SL resource allocation for the SL Tx UE 312 in response to the SL-SR. Upon receiving the SL resource allocation, the SL Tx UE 312 transmits an SL transmission to the SL Rx UE 313 based on the SL resource allocation via a physical sidelink control channel (PSCCH) or a physical sidelink shared channel (PSSCH). In response to the SL transmission, the SL Rx UE 313 transmits an SL feedback transmission to the SL Tx UE 312 via a physical sidelink feedback channel (PSFCH)

FIG. 3b illustrates NR SL mode 2. In NR SL mode 2, the SL UEs autonomously perform the resource selection with the aid of a sensing procedure. More specifically, an SL Tx UE in NR SL mode 2 first performs a sensing procedure over the configured SL transmission resource pool(s) during a sensing time window 321, in order to obtain knowledge of the resource(s) reserved by other nearby SL Tx UE(s). Based on the knowledge obtained from the sensing, the SL Tx UE may select resource(s) from the available SL resources accordingly during a selection time window 322. Resources deemed as available for selection for the next period may still need to have a listen-before-talk (LBT) check prior to access. In order for an SL UE to perform sensing and obtain the necessary information to receive a SL transmission, it needs to decode the sidelink control information (SCI). In NR Rel-16, the SCI associated with a data transmission includes a 1st stage SCI and a 2nd stage SCI.

SL resource allocation enhancement for NR SL mode 2 has been identified as one of the objectives, in which inter-UE coordination will be studied for enhanced reliability and reduced latency.

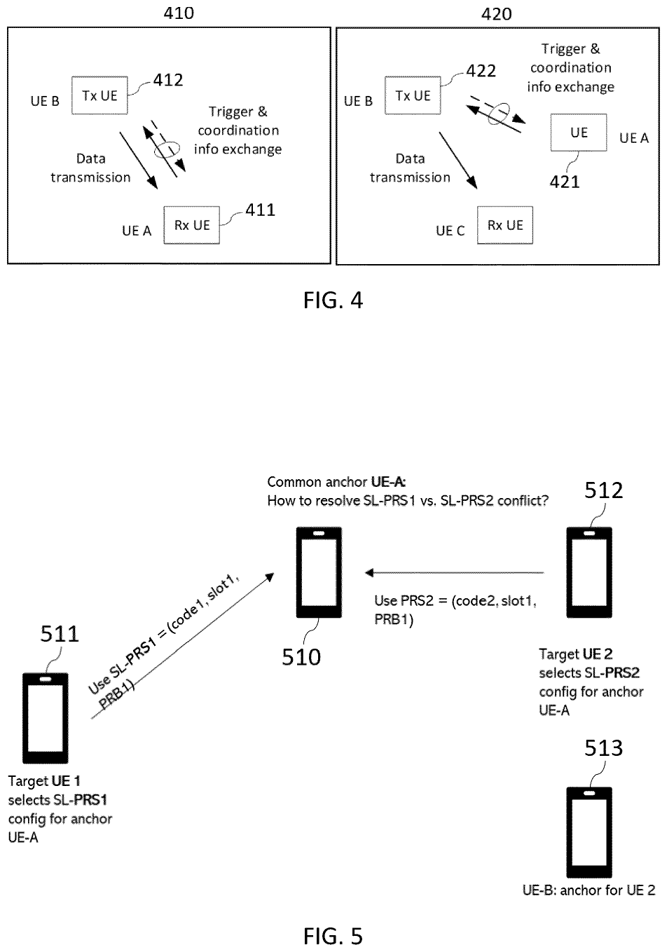

FIG. 4 illustrates inter-UE coordination scenarios. In a first inter-UE coordination scenario illustrated in block 410, the coordinating UE 411 (denoted as UE-A) is also the intended receiver of another UE's 412 (denoted as UE-B) transmission. UE-A 411 (Rx UE) selects the preferred SL transmit resource(s) (e.g., according to its sensing) and recommends the selected resource(s) to UE-B 412 (Tx UE). UE-B 412 selects its SL transmit resource by taking into account the resource(s) indicated by UE-A, and performs its own sensing in addition to that. For example, UE-B 412 may use or may not use the recommended resource(s) to transmit to UE-A 411. Thus, by using the inter-UE coordination scheme, UE-A 411 may try to ensure that there is no packet collision or strong interference over its selected resource(s), and thus the transmission from UE-B 412 to UE-A 411 may occur with high (er) reliability.

In a second inter-UE coordination scenario illustrated in block 420, the coordinating UE 421 (UE-A) is not the intended receiver of UE-B's 422 transmission. UE-A 421 monitors the transmissions taking place in the SL resource pool, and whenever a collision or half-duplex problem is detected (either in the past or in future resources), UE-A informs the impacted UEs.

SL transmissions may be organized in radio frames identified by the direct frame number (DFN). The DFN enables a UE to synchronize its radio frame transmissions according to the SL timing reference. UEs perform SL synchronization to have the same SL timing reference for SL communication among nearby UEs by synchronizing with a reference. For example, one of the following may be used as a source for the synchronization reference: a global navigation satellite system (GNSS), an NR cell (gNB), an E-UTRAN cell (eNB), a SyncRef UE, or the UE's own internal clock. Herein a SyncRef UE is a UE acting as a synchronization reference source that either extends the synchronization coverage of a synchronization source (e.g., GNSS, gNB/eNB or another SyncRef UE), or uses its own internal clock as the synchronization reference.

An NR positioning session may be configured and triggered by the location management function (LMF), which collects information from several transmission and reception points (TRP) regarding their availability to partake in helping the positioning of a given UE. This means that the LMF acts as a coordinator, i.e., a central network entity, which selects and configures the transmission of positioning reference signals (PRS) by several TRPs, so that the signals do not interfere with each other and they are easily distinguishable by the UE. The configuration of PRS means selecting the code-time-frequency-space resources that a given TRP should use to enable the localization (positioning) of the UE within precise latency and accuracy requirements.

In out-of-coverage (OOC) SL positioning, the LMF becomes unavailable, which means that the SL UEs need to find alternative ways to configure, trigger and successfully finalize the positioning session. One possible way for sidelink positioning reference signal (S-PRS) request and resource configuration is to enable the target UE (i.e., the UE in need of localization) to discover and configure other SL UEs, called anchor UEs, to transmit S-PRS according to a preferred resource configuration. In this way, the target UE takes the role of the LMF. However, this approach may lead to several target UEs choosing the same anchor UE and configuring the anchor UE's S-PRS transmission independent from each other. Since the different target UEs are unaware of each other, they may select conflicting S-PRS configurations for the same anchor, as shown in FIG. 5. In other words, the target UEs may configure an anchor UE with time, frequency and/or code parameters that are incompatible (or not preferred) with each other.

In the above situation, the anchor UE may need to solve the conflict, while ensuring that each positioning session does not exceed the allowed latency. However, this is not a straightforward task, since the anchor UE may know that two or more S-PRS configurations are conflicting for itself, but does not know what other S-PRS each target UE is expecting to receive, and from which anchor UE. FIG. 5 illustrates an example of the S-PRS conflict scenario. A first target UE 511 (UE1) transmits a first S-PRS resource configuration (SL-PRS1) to an anchor UE 510 (UE-A). A second target UE 512 (UE2) transmits a second S-PRS resource configuration (SL-PRS2) to the same anchor UE 510 (UE-A). The common anchor UE 510 (UE-A) needs to resolve the SL-PRS1 vs. SL-PRS2 conflicting requests. The anchor UE 510 may decide to use one of the two (e.g., use SL-PRS1 to serve both the first target UE 511 and the second target UE 512 simultaneously, and inform the second target UE 512 about the S-PRS resource configuration change). While SL-PRS1 may be preferred by the first target UE 511, not only may that SL-PRS1 be suboptimal for the channel conditions towards the second target UE 512, but it may also be chosen by yet another anchor UE of the second target UE, e.g., a second anchor UE 513 (UE-B). In this case, the second target UE 512 may end up having to simultaneously receive the same signal from two different anchor UEs, which makes the anchor UEs indistinguishable.

Thus, there is a challenge in how to avoid multiple S-PRS conflicts, which may occur when one or more common anchor UEs are configured with incompatible time, frequency, and/or code parameter settings by two or more independent target UEs that are out-of-coverage.

Some exemplary embodiments may help to avoid the conflicting S-PRS resource configurations by making the target UE enable the anchor UE(s) to conditionally accept and modify the positioning session configuration (S-PRS configuration). In other words, some exemplary embodiments provide a procedure that mitigates the occurrence of S-PRS resource configuration conflicts. Such S-PRS resource conflicts may occur, when one or more common anchor UEs are configured simultaneously and independently by two or more target UEs with incompatible time, frequency and/or code parameter settings.

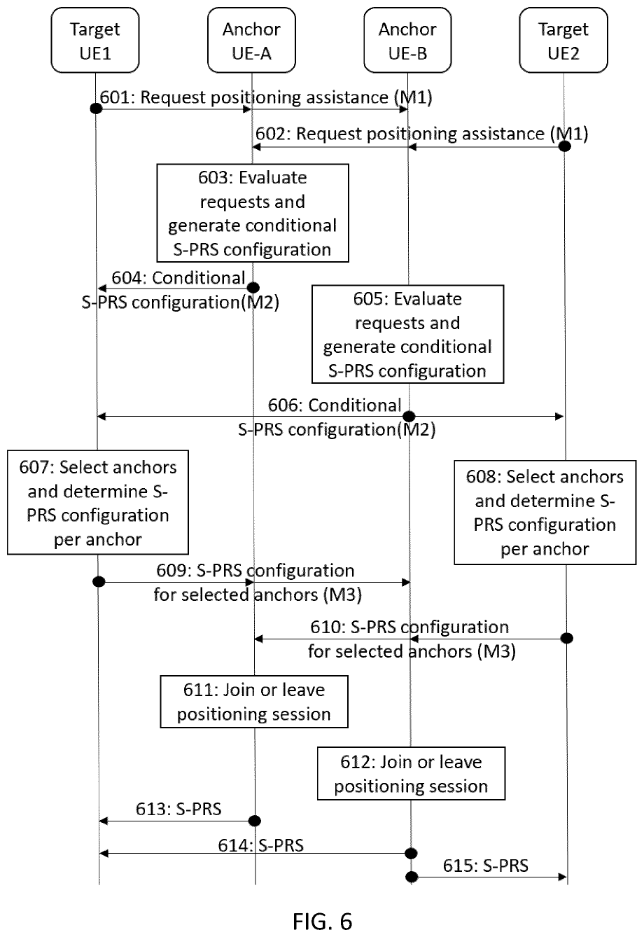

FIG. 6 illustrates a signaling diagram according to an exemplary embodiment, wherein a double-handshake is applied to ensure a conflict-less S-PRS resource selection.

Referring to FIG. 6, in step 601, a first target UE (UE1) transmits, or broadcasts, a request for positioning assistance to one or more anchor UEs. In other words, with the request for positioning assistance, the first target UE requests one or more other nearby UEs to assist with localizing (positioning) the first target UE, and to join the positioning session of the first target UE as an anchor UE. For example, the request may reach at least a first anchor UE (UE-A) and a second anchor UE (UE-B). The request may be transmitted, for example, in a first sidelink message M1, which may indicate a selected set of preferred and/or non-preferred resource configurations (from the perspective of the first target UE) for an S-PRS transmission, as well as the session dimensioning. For example, the first target UE may inform the first anchor UE and the second anchor UE of the number of independent positioning signals needed. The first sidelink message M1 transmitted by the first target UE may further comprise the first target UE's layer 1 (L1) identity (ID) in the 2^{nd} stage SCI, as well as the first target UE's positioning requirement(s) (e.g., in a MAC control element, CE, or a new 2^{nd} stage SCI format). The positioning requirement(s) may comprise, for example, a positioning latency requirement and/or a positioning accuracy requirement.

In one example, the first target UE may append to the broadcasted message M1 (e.g., as a MAC CE or additional elements on a new 2nd stage SCI format) at least one of: a first set (e.g., an ordered list) of N₁ preferred S-PRS resource configurations (e.g., preferred time-frequency-code resources), and/or a minimum number M (M≤N₁) of preferred S-PRS resource configurations that each anchor UE should select and reply.

In another example, the first target UE may append to the broadcast message M1 (e.g., as a MAC CE or additional elements on a new 2nd stage SCI format) at least one of: a first set (e.g., a list) of N₂ non-preferred S-PRS resource configurations out of N possible S-PRS resource configurations, and/or a minimum number M (M≤N−N₂) of S-PRS resource configurations excluding the non-preferred S-PRS resource configurations that each anchor UE should select and reply. From the perspective of the first target UE, a non-preferred S-PRS resource configuration may be due to that S-PRS resource configuration not being possible to be used by the first target UE (e.g., due to a conflicting action in the associated time-and-frequency resources, such as the first target UE performing a transmission at that time and therefore not being able to receive any S-PRS transmission).

An S-PRS resource configuration may comprise at least one of the following fields: resource pool identification (ID), S-PRS transmission slot, S-PRS starting sub-channel, S-PRS bandwidth, S-PRS generating root sequence number, S-PRS generating root sequency length, S-PRS cyclic shift, S-PRS number of repetitions, and/or S-PRS symbols in the sidelink slot. The resource pool ID indicates the sidelink resource pool, where the anchor UE should perform the S-PRS transmission. The S-PRS transmission slot indicates the time-domain location (i.e., location in time), where the S-PRS should be transmitted. The S-PRS starting sub-channel indicates the frequency-domain location (i.e., location in frequency), where the S-PRS should be transmitted. The S-PRS bandwidth indicates the number of sub-channels used for the S-PRS transmission. S-PRS generating root sequence number indicates the seed used to generate the Zadoff-Chu root sequence for the S-PRS. The S-PRS generating root sequence length indicates the length of the Zadoff-Chu root sequence. The S-PRS cyclic shift indicates the cyclic shift applied by the transmitter of the S-PRS sequence. The S-PRS number of repetitions indicates the number of repetitions requested for the S-PRS transmission by the target UE (e.g., the first target UE or the second target UE). The S-PRS symbols in the sidelink slot indicates the symbols in the SL slot that will be used for the S-PRS transmission.

In other words, the S-PRS resource configuration may indicate, for example, time and frequency resources, where the anchor UE should send the respective S-PRS, as well as the generating root sequence and cyclic shift applied for the S-PRS. For example, the S-PRS may be generated via a Zadoff-Chu sequence, or an equivalent sequence with the same properties.

In step 602, a second target UE (UE2) transmits, or broadcasts, a request for positioning assistance to one or more anchor UEs. In other words, with the request for positioning assistance, the second target UE requests one or more other nearby UEs to assist with localizing the second target UE, and to join the positioning session of the second target UE as an anchor UE. For example, the request may reach at least the first anchor UE (UE-A) and the second anchor UE (UE-B). The request may be transmitted, for example, in another first sidelink message M1, which may indicate a selected set of preferred, or non-preferred, resource configurations (from the perspective of the second target UE) for an S-PRS transmission, as well as the session dimensioning. For example, the second target UE may inform the first anchor UE and the second anchor UE of the number of independent positioning signals needed. The first sidelink message M1 transmitted by the second target UE may further comprise the second target UE's layer 1 (L1) identity (ID) in the 2^{nd} stage SCI, as well as the second target UE's positioning requirement(s) (e.g., in a MAC CE or a new 2^{nd} stage SCI format).

In step 603, upon receiving the first sidelink message M1 from one or more target UEs (e.g., from the first target UE and/or the second target UE), the first anchor UE evaluates the content of the positioning assistance request(s), and generates one or more conditional S-PRS resource configurations to serve the one or more target UEs. A conditional S-PRS resource configuration means that the first anchor UE will join the positioning session of a given target UE, if the target UE accepts the conditional S-PRS resource configuration provided by the first anchor UE. In other words, the first anchor UE processes the request to enter a positioning session from the one or more target UEs, and it may accept or reject to join the positioning session based on the evaluation of the request. This evaluation may be based on the preferred and/or non-preferred S-PRS configuration(s) indicated by a given target UE. For example, if the first anchor UE is only able to provide positioning assistance using the non-preferred S-PRS configuration(s) indicated by a given target UE, then the first anchor UE may evaluate that it will not be able to assist the positioning of that target UE. For example, based on the evaluating, the first anchor UE may determine to enter the positioning session initiated by the first target UE, but not the positioning session initiated by the second target UE.

In step 604, the first anchor UE transmits, to the first target UE, an indication for conditional positioning assistance. The indication for conditional positioning assistance may be transmitted, for example, in a second sidelink message M2, which may comprise a conditional S-PRS resource configuration for the first target UE. The second sidelink message M2 transmitted by the first anchor UE may further comprise the L1 ID of the first anchor UE (as transmitter), and the L1 ID of the first target UE (as receiver) for example in the 2^{nd} stage SCI.

In one example, the second SL message M2 transmitted by the first anchor UE may indicate a second set (e.g., a list) of M≤N₁ preferred S-PRS resource configurations (from the perspective of the first anchor UE) or M (M≤N−N₂)S-PRS resource configurations that excludes the non-preferred S-PRS resource configuration(s) (if indicated by the first target UE in step 601) in a MAC CE or additional elements on a new 2^{nd} stage SCI format.

In another example, the second sidelink message M2 transmitted by the first anchor UE may indicate a second set of non-preferred S-PRS resource configurations (from the perspective of the first anchor UE) for example in a MAC CE or additional elements on a new 2^{nd} stage SCI format. From the perspective of the first anchor UE, a non-preferred S-PRS resource configuration may be due to that S-PRS resource configuration not being possible to be used by the first anchor UE (e.g., due to a conflicting action in the associated time-and-frequency resources, such as the first anchor UE having to perform a reception at that time and therefore not being able to perform a S-PRS transmission). The non-preferred S-PRS resources configurations are UE-specific and related to each UE's own constraints, and thus the non-preferred S-PRS resource configuration(s) indicated by the first anchor UE in the second sidelink message M2 are independent from the non-preferred S-PRS resource configuration(s) indicated by the first and second target UE in the first sidelink messages M1.

It should be noted that the anchor UE reply message (i.e., the second sidelink message M2) may also be broadcasted, in which case other target UE(s) may use it to initialize their own upcoming positioning sessions

In step 605, upon receiving the first sidelink message M1 from one or more target UEs (e.g., from the first target UE and/or the second target UE), the second anchor UE evaluates the content of the request(s), and generates a conditional S-PRS resource configuration to serve the one or more target UEs. In other words, the second anchor UE processes the request to enter a positioning session from the one or more target UEs. For example, based on the evaluating, the second anchor UE may determine to enter the positioning sessions initiated by both the first target UE and the second target UE.

In step 606, the second anchor UE transmits, to the first target UE and to the second target UE, an indication for conditional positioning assistance. The indication for conditional positioning assistance may be transmitted, for example, in one or more second sidelink messages M2. The one or more second sidelink messages M2 transmitted by the second anchor UE may comprise a conditional S-PRS resource configuration for the first target UE, as well as a conditional S-PRS resource configuration for the second target UE. The conditional S-PRS resource configurations for the two target UEs may be transmitted in separate messages, or they may be transmitted in the same message. For example, the conditional S-PRS resource configurations for the two target UEs may be multiplexed in the same payload by using separate MAC CEs addressed to each target UE.

In step 607, the first target UE processes, or evaluates, the information received in the second sidelink messages M2 from the first anchor UE and the second anchor UE, and the first target UE configures its own positioning session by activating some, or all, or none of the responsive anchor UEs (e.g., the first anchor UE and/or the second anchor UE), from which the first target UE received the second sidelink messages M2. In other words, the first target UE collects the replies (M2 messages) from K₁ responsive anchor UEs, and evaluates each anchor UE's M preferences and/or non-preference in the S-PRS resource configuration against one or more of its own positioning requirements. The one or more positioning requirements may comprise, for example, a positioning latency requirement and/or a positioning accuracy requirement. The first target UE may select K₂ out of K₁ (K₂≤K₁) responsive anchor UEs, and determine an S-PRS resource configuration per selected anchor UE. For example, the first target UE may select a given anchor UE, if that anchor UE indicated at least one preferred S-PRS resource configuration that fulfills the one or more positioning requirements of the first target UE, or if the non-preferred S-PRS resource configuration(s) indicated by that anchor UE enable selecting an S-PRS resource configuration that fulfills the one or more positioning requirements of the first target UE. The S-PRS resource configuration for a given anchor UE may be determined by selecting one of the preferred S-PRS configuration(s) indicated by that anchor UE that fulfill the one or more positioning requirements, or by selecting an S-PRS configuration that fulfills the one or more positioning requirements and does not conflict with the non-preferred S-PRS configuration(s) indicated by that anchor UE.

In step 608, the second target UE processes the information received in the second sidelink message M2 from the second anchor UE, and the second target UE configures its own positioning session by activating some, or all, or none of the responsive anchor UEs (e.g., the second anchor UE), from which the second target UE received the second sidelink message M2. The second target UE may select one or more responsive anchor UEs, and determine an S-PRS resource configuration per selected anchor UE.

In step 609, the first target UE transmits, or broadcasts, an anchor selection message to the one or more (K₂) anchor UEs selected by the first target UE. The anchor selection message may also be referred to as a third sidelink message M3 herein. The sidelink positioning session may be triggered by broadcasting the agreed configuration via the third sidelink message M3.

The third sidelink message M3 may comprise a list of the one or more (K₂) anchor UEs selected by the first target UE, as well as the associated S-PRS resource configuration per selected anchor UE. In other words, the third sidelink message M3 may comprise an L1 ID of the one or more anchor UEs selected by the first target UE and an associated S-PRS configuration per selected anchor UE. For example, the third sidelink message M3 may comprise a first L1 ID and a first S-PRS configuration associated with the first anchor UE, and/or a second L1 ID and a second S-PRS configuration associated with the second anchor UE. The S-PRS configuration may comprise, for example, time and frequency resources, where the anchor UE should send the respective S-PRS, as well as the actual generating root sequence and cyclic shift applied for the S-PRS. This information may be provided, for example, in a MAC CE, so that it can be decoded by the selected one or more anchor UEs, as well as by other anchor UEs and other target UEs.

It should be noted that the broadcasted M3 message may also be heard by one or more other target UEs, which may use it to initialize its own positioning session (i.e., use it to generate its own positioning assistance request message M1). For example, the one or more other target UEs may use the S-PRS configuration assignment indicated in the third sidelink message M3 broadcasted from the first target UE for generating a list of preferred or non-preferred S-PRS resource configurations to avoid the conflict.

In step 610, the second target UE transmits, or broadcasts, an anchor selection message (third sidelink message M3) to the one or more anchor UEs selected by the second target UE. The sidelink positioning session may be triggered by broadcasting the agreed configuration via the M3 message. As described above, the anchor selection message may comprise a list of the one or more anchor UEs selected by the second target UE, as well as an associated S-PRS resource configuration per selected anchor UE.

In step 611, the first anchor UE processes the information received in the third sidelink message M3 from the first target UE and/or the second target UE, and the first anchor UE joins the positioning session of the first target UE, if the first anchor UE is in the list of selected anchor UEs provided by the first target UE.

In step 612, the second anchor UE processes the information received in the third sidelink message M3 from the first target UE and/or the second target UE, and the second anchor UE joins the positioning session of the first target UE and the positioning session of the second target UE, if the second anchor UE is in the list of selected anchor UEs provided by the first target UE, and in the list of selected anchor UEs provided by the second target UE.

In other words, all of the responsive anchor UEs within the range of the broadcast may hear the M3 message broadcasted from the first target UE and the second target UE, and a given anchor UE may join the positioning session of the first target UE and/or the second target UE, if their L1 ID is on the list of selected anchor UEs provided by the first target UE and/or the second target UE, respectively. Otherwise (if its L1 ID is not on the list), a given anchor UE may remain silent and leave the positioning session of the respective target UE.

In step 613, upon joining the positioning session of the first target UE, the first anchor UE transmits an S-PRS transmission to the first target UE based at least partly on the S-PRS configuration indicated for the first anchor UE by the first target UE in step 609. The first target UE may estimate a location of the first target UE based at least partly on the S-PRS transmission received from the first anchor UE.

In step 614, upon joining the positioning session of the first target UE, the second anchor UE transmits an S-PRS transmission to the first target UE based at least partly on the S-PRS configuration indicated for the second anchor UE by the first target UE in step 609. The first target UE may estimate the location of the first target UE based at least partly on the S-PRS transmission received from the second anchor UE.

In step 615, upon joining the positioning session of the second target UE, the second anchor UE transmits an S-PRS transmission to the second target UE based at least partly on the S-PRS configuration indicated for the second anchor UE by the second target UE in step 609. The second target UE may estimate a location of the second target UE based at least partly on the S-PRS transmission received from the second anchor UE.

It should be noted that some exemplary embodiments are not restricted to S-PRS, and other reference signals may also be used instead of S-PRS. For example, a demodulation reference signal (DMRS) associated with the PSCCH and PSSCH, PSFCH or the SL channel state information (CSI) may be used instead of S-PRS. However, S-PRS may provide better positioning performance compared to other reference signals, such as DMRS.

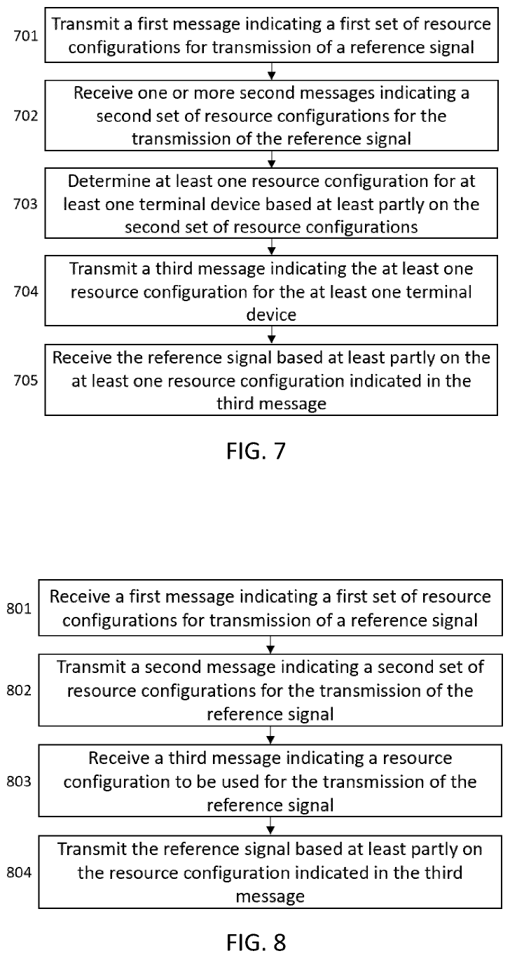

FIG. 7 illustrates a flow chart according to an exemplary embodiment. The steps illustrated in FIG. 7 may be performed by an apparatus such as, or comprised in, a target UE. The target UE may also be referred to as a first target UE, a second target UE, or a second terminal device herein.

Referring to FIG. 7, in step 701, a first message is transmitted, wherein the first message indicates a first set of resource configurations for transmission of a reference signal. For example, the reference signal may be a sidelink reference signal, such as a sidelink positioning reference signal (S-PRS). The first message may refer to, for example, the first sidelink message M1 described above with reference to FIG. 6.

In step 702, one or more second messages are received from one or more terminal devices (e.g., one or more anchor UEs), wherein the one or more second messages indicate a second set of resource configurations for the transmission of the reference signal from the one or more terminal devices. The second message may refer to, for example, the second sidelink message M2 described above with reference to FIG. 6. For example, the second set of resource configurations may comprise one or more preferred resource configurations from the first set of resource configurations indicated in the first message. Alternatively or additionally, the second set of resource configurations may exclude one or more non-preferred e configurations from the first set of resource configurations.

In step 703, at least one resource configuration to be used for the transmission of the reference signal is determined for at least one terminal device of the one or more terminal devices based at least partly on the second set of resource configurations.

In step 704, a third message indicating the at least one resource configuration for the at least one terminal device is transmitted. The third message may refer to, for example, the third sidelink message M3 described above with reference to FIG. 6.

In step 705, the reference signal is received from the at least one terminal device based at least partly on the at least one resource configuration indicated in the third message.

FIG. 8 illustrates a flow chart according to an exemplary embodiment. The steps illustrated in FIG. 8 may be performed by an apparatus such as, or comprised in, an anchor UE. The anchor UE may also be referred to as a first anchor UE, a second anchor UE, or a first terminal device herein.

Referring to FIG. 8, in step 801, a first message is received from a terminal device (e.g., a target UE), wherein the first message indicates a first set of resource configurations for transmission of a reference signal to the terminal device. For example, the reference signal may be a sidelink reference signal, such as a sidelink positioning reference signal (S-PRS). The first message may refer to, for example, the first sidelink message M1 described above with reference to FIG. 6.

In step 802, a second message indicating a second set of resource configurations for the transmission of the reference signal to the terminal device is transmitted, wherein the second set of resource configurations are generated based at least partly on the first set of resource configurations. The second message may refer to, for example, the second sidelink message M2 described above with reference to FIG. 6.

In step 803, a third message is received from the terminal device, wherein the third message indicates a resource configuration to be used for the transmission of the reference signal to the terminal device. The third message may refer to, for example, the third sidelink message M3 described above with reference to FIG. 6. The resource configuration indicated in the third message may be based at least partly on the second set of resource configurations indicated in the second message.

In step 804, the reference signal is transmitted to the terminal device based at least partly on the resource configuration indicated in the third message.

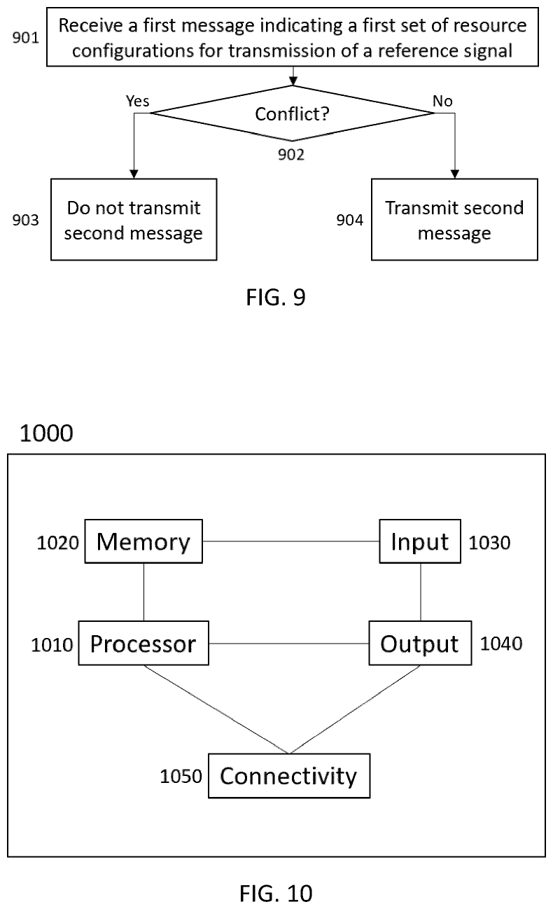

FIG. 9 illustrates a flow chart according to another exemplary embodiment. The steps illustrated in FIG. 9 may be performed by an apparatus such as, or comprised in, an anchor UE. The anchor UE may also be referred to as a first anchor UE, a second anchor UE, or a first terminal device herein.

Referring to FIG. 9, in step 901, the anchor UE receives a first message from a target UE, wherein the first message indicates a positioning assistance request and a first set of one or more preferred reference signal resource configurations (e.g., S-PRS configurations) from the perspective of the target UE. The first message may refer to, for example, the first sidelink message M1 described above with reference to FIG. 6.

In step 902, the anchor UE determines whether or not to respond to the first message based at least partly on one or more acceptable resource configurations that are available for use for the transmission of the reference signal at the anchor UE. The one or more acceptable resource configurations refer to resource configurations that are not being used by the anchor UE. For example, if the one or more preferred resource configurations conflict with a resource configuration that the anchor UE is already using, then the anchor UE may not be able to provide the one or more preferred resource configurations to the target UE.

Hence, if there is such a conflict (902: yes), then in step 903 the anchor UE may choose to not join the positioning session with the target UE. In this case, there may be no reply (second message) from the anchor UE to the positioning assistance request (first message) from the target UE.

On the other hand, if at least one of the preferred resource configuration(s) indicated by the target UE do not conflict (902: no) with the resource configuration that the anchor UE is already using, then in step 904 the anchor UE transmits the second message to the target UE. The second message may indicate a second set of one or more preferred and/or non-preferred reference signal resource configurations (e.g., S-PRS resource configurations) from the perspective of the anchor UE. The second message may refer to, for example, the second sidelink message M2 described above with reference to FIG. 6.

The steps and/or blocks described above by means of FIGS. 6-9 are in no absolute chronological order, and some of them may be performed simultaneously or in an order differing from the described one. Other steps and/or blocks may also be executed between them or within them.

A technical advantage provided by some exemplary embodiments is that they enable the anchor and target UEs to mitigate the occurrence of S-PRS resource conflicts, when an anchor UE needs to participate in multiple positioning sessions.

FIG. 10 illustrates an apparatus 1000, which may be an apparatus such as, or comprised in, a terminal device, according to an exemplary embodiment. The terminal device may also be referred to as a first terminal device, a second terminal device, a UE, an anchor UE, a first anchor UE, a second anchor UE, a target UE, a first target UE, a second target UE, or user equipment herein. The apparatus 1000 comprises a processor 1010. The processor 1010 interprets computer program instructions and processes data. The processor 1010 may comprise one or more programmable processors. The processor 1010 may comprise programmable hardware with embedded firmware and may, alternatively or additionally, comprise one or more application-specific integrated circuits (ASICs).

The processor 1010 is coupled to a memory 1020. The processor is configured to read and write data to and from the memory 1020. The memory 1020 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1020 stores computer readable instructions that are executed by the processor 1010. For example, non-volatile memory stores the computer readable instructions and the processor 1010 executes the instructions using volatile memory for temporary storage of data and/or instructions.

The computer readable instructions may have been pre-stored to the memory 1020 or, alternatively or additionally, they may be received, by the apparatus, via an electromagnetic carrier signal and/or may be copied from a physical entity such as a computer program product. Execution of the computer readable instructions causes the apparatus 1000 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1000 may further comprise, or be connected to, an input unit 1030. The input unit 1030 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1030 may comprise an interface to which external devices may connect to.

The apparatus 1000 may also comprise an output unit 1040. The output unit may comprise or be connected to one or more displays capable of rendering visual content, such as a light emitting diode (LED) display, a liquid crystal display (LCD) and/or a liquid crystal on silicon (LCoS) display. The output unit 1040 may further comprise one or more audio outputs. The one or more audio outputs may be for example loudspeakers.

The apparatus 1000 further comprises a connectivity unit 1050. The connectivity unit 1050 enables wireless connectivity to one or more external devices. The connectivity unit 1050 comprises at least one transmitter and at least one receiver that may be integrated to the apparatus 1000 or that the apparatus 1000 may be connected to. The at least one transmitter comprises at least one transmission antenna, and the at least one receiver comprises at least one receiving antenna. The connectivity unit 1050 may comprise an integrated circuit or a set of integrated circuits that provide the wireless communication capability for the apparatus 1000. Alternatively, the wireless connectivity may be a hardwired application-specific integrated circuit (ASIC). The connectivity unit 1050 may comprise one or more components such as a power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1000 may further comprise various components not illustrated in FIG. 10. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus comprising at least one processor, and at least one memory including computer program code, wherein the at least one memory and the computer program code are configured, with the at least one processor, to cause the apparatus to:
receive, from a terminal device, a first message indicating a first set of resource configurations for transmission of a reference signal to the terminal device;
transmit a second message indicating a second set of resource configurations for the transmission of the reference signal to the terminal device, wherein the second set of resource configurations are generated based at least partly on the first set of resource configurations;
receive, from the terminal device, a third message indicating a resource configuration to be used for the transmission of the reference signal to the terminal device; and
transmit, to the terminal device, the reference signal based at least partly on the resource configuration indicated in the third message.

2. The apparatus according to claim 1, wherein the second set of resource configurations comprises one or more preferred resource configurations from the first set of resource configurations indicated in the first message.

3. The apparatus according to claim 1, wherein the second set of resource configurations excludes one or more resource configurations from the first set of resource configurations.

4. The apparatus according to claim 1, wherein the first message indicates a minimum number of preferred resource configurations for the transmission of the reference signal to the terminal device,
wherein the second set of resource configurations is generated based at least partly on the minimum number of preferred resource configurations for the transmission of the reference signal to the terminal device.

5. The apparatus according to claim 1, wherein the minimum number of preferred resource configurations excludes one or more non-preferred resource configurations from the first set of resource configurations indicated in the first message for the transmission of the reference signal to the terminal device.

6. The apparatus according to claim 1, wherein the apparatus is further caused to:
determine whether to respond to the first message based at least partly on one or more resource configurations available for use for the transmission of the reference signal.

7. The apparatus according to claim 1, wherein:
the first message comprises an identity of the terminal device;
the second message comprises the identity of the terminal device and an identity of the apparatus; and
the third message comprises the identity of the apparatus.

8. The apparatus according to claim 1, wherein the resource configuration indicates at least one of: a resource pool for the reference signal, a time-domain location of the reference signal, a frequency-domain location of the reference signal, a number of sub-channels used for the reference signal, a seed for generating a Zadoff-Chu root sequence for the reference signal, a length of the Zadoff-Chu root sequence for the reference signal, a cyclic shift applied in the transmission of the reference signal, a number of repetitions requested for the transmission of the reference signal, and/or one or more symbols in a time slot used for the transmission of the reference signal.

9. The apparatus according to claim 1, wherein the reference signal is a sidelink reference signal.

10. The apparatus according to claim 1, wherein the sidelink reference signal is a sidelink positioning reference signal.

11. An apparatus comprising at least one processor, and at least one memory including computer program code, wherein the at least one memory and the computer program code are configured, with the at least one processor, to cause the apparatus to:
transmit a first message indicating a first set of resource configurations for transmission of a reference signal;
receive, from one or more terminal devices, one or more second messages indicating a second set of resource configurations for the transmission of the reference signal from the one or more terminal devices;
determine, based at least partly on the second set of resource configurations, at least one resource configuration to be used for the transmission of the reference signal for at least one terminal device of the one or more terminal devices;
transmit a third message indicating the at least one resource configuration for the at least one terminal device; and
receive, from the at least one terminal device, the reference signal based at least partly on the at least one resource configuration indicated in the third message.

12. The apparatus according to claim 11, wherein the second set of resource configurations comprises one or more preferred resource configurations from the first set of resource configurations indicated in the first message.

13. The apparatus according to claim 11, wherein the second set of resource configurations excludes one or more resource configurations from the first set of resource configurations.

14. The apparatus according to claim 11, wherein the first message indicates a minimum number of preferred resource configurations for the transmission of the reference signal, wherein the minimum number of preferred resource configurations excludes one or more non-preferred resource configurations from the first set of resource configurations indicated in the first message for the transmission of the reference signal.

15. (canceled)

16. The apparatus according to claim 11, wherein:
the first message comprises an identity of the apparatus;
the one or more second messages comprise the identity of the apparatus and an identity of the one or more terminal devices; and
the third message comprises an identity of the at least one terminal device.

17. The apparatus according to claim 11, wherein the at least one resource configuration indicates at least one of: a resource pool for the reference signal, a time-domain location of the reference signal, a frequency-domain location of the reference signal, a number of sub-channels used for the reference signal, a seed for generating a Zadoff-Chu root sequence for the reference signal, a length of the Zadoff-Chu root sequence for the reference signal, a cyclic shift applied in the transmission of the reference signal, a number of repetitions requested for the transmission of the reference signal, and/or one or more symbols in a slot used for transmission of the reference signal.

18. The apparatus according to claim 11, wherein the apparatus is further caused to:
select, based at least partly on one or more positioning requirements of the apparatus, the at least one terminal device from the one or more terminal devices.

19. The apparatus according to claim 11, wherein the reference signal is a sidelink reference signal, and the sidelink reference signal is a sidelink positioning reference signal.

20-22. (canceled)

23. A method comprising:
receiving, by a first terminal device, from a second terminal device, a first message indicating a first set of resource configurations for transmission of a reference signal to the second terminal device;
transmitting, by the first terminal device, a second message indicating a second set of resource configurations for the transmission of the reference signal to the second terminal device, wherein the second set of resource configurations are generated based at least partly on the first set of resource configurations;
receiving, by the first terminal device, from the second terminal device, a third message indicating a resource configuration to be used for the transmission of the reference signal to the second terminal device; and
transmitting, by the first terminal device, to the second terminal device, the reference signal based at least partly on the resource configuration indicated in the third message.

24. A method comprising:
transmitting, by a second terminal device, a first message indicating a first set of resource configurations for transmission of a reference signal;
receiving, by the second terminal device, from one or more first terminal devices, one or more second messages indicating a second set of resource configurations for the transmission of the reference signal from the one or more first terminal devices;
determining, by the second terminal device, based at least partly on the second set of resource configurations, at least one resource configuration to be used for the transmission of the reference signal for at least one terminal device of the one or more first terminal devices;
transmitting, by the second terminal device, a third message indicating the at least one resource configuration for the at least one terminal device; and
receiving, by the second terminal device, from the at least one terminal device, the reference signal based at least partly on the at least one resource configuration indicated in the third message.

25-28. (canceled)
